(19) United States
(12) Patent Application Publication
(10) Pub. No.: US 2024/0397005 A1
(43) Pub. Date: Nov. 28, 2024

(54) IMAGE PROCESSING SYSTEM, NON-TRANSITORY COMPUTER READABLE MEDIUM STORING PROGRAM, AND IMAGE PROCESSING METHOD

(71) Applicant: FUJIFILM Business Innovation Corp., Tokyo (JP)

(72) Inventor: Kazutoshi SUZUKI, Kanagawa (JP)

(73) Assignee: FUJIFILM Business Innovation Corp., Tokyo (JP)

(21) Appl. No.: 18/507,076

(22) Filed: Nov. 12, 2023

(30) Foreign Application Priority Data
May 25, 2023 (JP) 2023-086233

(51) Int. Cl. H04N 1/00

(52) U.S. Cl. CPC H04N 1/00588; H04N 1/00477; H04N 1/00663; H04N 1/00702

(57) ABSTRACT

An image processing system includes one or plural processors configured to, in an operation mode in which an image is scanned from a document being transported by a transport mechanism, in a case where transport of the document by the transport mechanism is stopped and then the transport is restarted before scanning of the document by the transport mechanism is ended, create a scanned image of the document by using a document image scanned before stop of the transport and a document image scanned by restart of the transport, based on information indicating a movement of the document at a time of stopping the transport.

### CROSS-REFERENCE TO RELATED APPLICATIONS

This application is based on and claims priority under 35 USC 119 from Japanese Patent Application No. 2023-086233 filed May 25, 2023.

### BACKGROUND

### (i) Technical Field

The present invention relates to an image processing system, a non-transitory computer readable medium storing a program, and an image processing method.

### (ii) Related Art

For example, JP2016-1795A discloses a configuration including a specifying section, a determination section, and a transport control section. The specifying section specifies a skew amount of a document based on a scanned image of the document obtained by scanning of an image scanning unit while transporting the document by a transport unit. The determination section determines whether or not to be able to transport the document based on the skew amount specified by the specifying section and a threshold value set in advance. The transport control section controls the transport unit to suppress transport of the document in a case where the determination section determines that the transport of the document is not possible.

### SUMMARY

Here, in a configuration of scanning a document being transported, for example, in a case where the document may come into contact with a document guide due to meandering of the document to the right or left, for example, and transport of the document is stopped, scanning is restarted from a first portion of the document, and thus it takes time to complete scanning.

Aspects of non-limiting embodiments of the present disclosure relate to an image processing system, a non-transitory computer readable medium storing a program, and an image processing method that reduce time taken to complete scanning, as compared with a case where transport of a document is stopped in scanning the document being transported, and the scanning is restarted from a first portion of the document.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image processing system including one or a plurality of processors configured to, in an operation mode in which an image is scanned from a document being transported by a transport mechanism, in a case where transport of the document by the transport mechanism is stopped and then the transport is restarted before scanning of the document by the transport mechanism is ended, create a scanned image of the document by using a document image scanned before stop of the transport and a document image scanned by restart of the transport, based on information indicating a movement of the document at a time of stopping the transport.

### BRIEF DESCRIPTION OF THE DRAWINGS

Exemplary embodiment(s) of the present invention will be described in detail based on the following figures, wherein:

FIG. 1 is a diagram illustrating an example of an image processing system;

FIG. 2 is a diagram illustrating an example of a hardware configuration of an information processing unit provided in an image forming apparatus and a server apparatus;

FIGS. 3A and 3B are diagrams illustrating a configuration of an image scanning device, where FIG. 3A is a plan view and FIG. 3B illustrates a portion of a transport mechanism;

FIGS. 4A and 4B are diagrams illustrating a scanning operation mode of the image scanning device, where FIG. 4A illustrates a case where transport of a document is stopped, and FIG. 4B illustrates a case where a document is moved from stop of transport to restart of the transport;

FIGS. 5A and 5B are diagrams illustrating information indicating a movement of a document in a case where transport is stopped, where FIG. 5A is a diagram corresponding to FIG. 4B, and FIG. 5B is a diagram illustrating a method for calculating a movement amount and a rotation angle;

FIG. 6 is diagrams illustrating creation of a scanned image by combination, where (a) of FIG. 6 is a diagram illustrating a document, (b) of FIG. 6 is a diagram illustrating a document image, and (c) of FIG. 6 is a diagram illustrating a combined image;

FIG. 7 is a block diagram illustrating a functional configuration in the present exemplary embodiment;

FIG. 8 is a flowchart illustrating a processing procedure in a case where scanning is performed;

FIG. 9 is a diagram illustrating a first display example of an operation reception unit; and

FIGS. 10A and 10B are diagrams illustrating other display examples of the operation reception unit, where FIG. 10A illustrates a second display example, and FIG. 10B illustrates a third display example.

### DETAILED DESCRIPTION

Hereinafter, an exemplary embodiment of the present invention will be described with reference to the accompanying drawings.

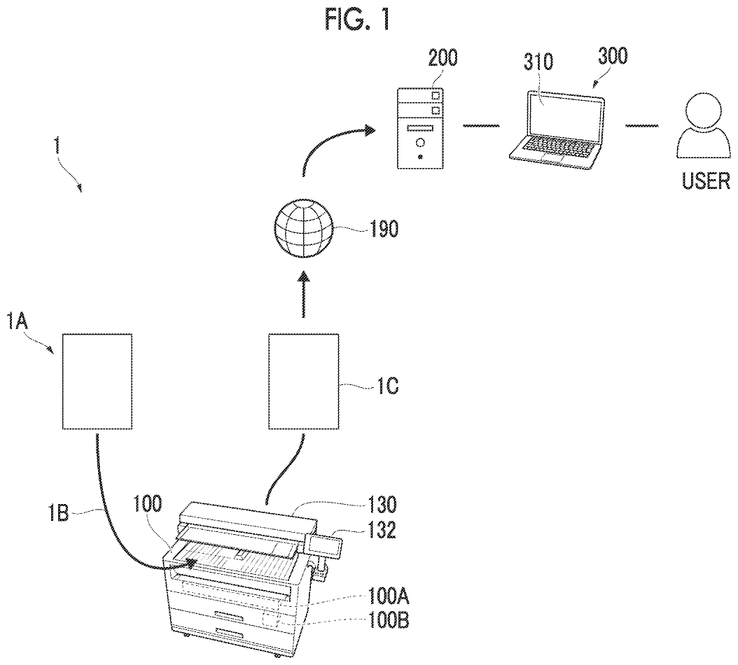

FIG. 1 is a diagram illustrating an example of an image processing system 1.

The image processing system 1 in the present exemplary embodiment is provided with an image forming apparatus 100 and a server apparatus 200 connected to the image forming apparatus 100 via a communication line 190. In the present exemplary embodiment, a document 1A is scanned in the image forming apparatus 100 as an example of the image processing system, and the scanned image 1C is created.

Further, the image processing system 1 in the present exemplary embodiment is provided with a user terminal 300 that is connected to the server apparatus 200 and receives an operation from a user.

The user terminal 300 is provided with a display device 310. The user terminal 300 is realized by a computer. Examples of the form of the user terminal 300 include a personal computer (PC), a smartphone, and a tablet terminal.

The image forming apparatus 100 is provided with an image forming unit 100A that forms an image on paper which is an example of a recording medium.

For example, the formation of an image on paper by the image forming unit 100A is performed by an inkjet method or an electrophotographic method. In addition, the formation of an image on paper by the image forming unit 100A is not limited to the inkjet method or the electrophotographic method, and may be performed by other methods.

The image forming apparatus 100 is further provided with an information processing unit 100B. The information processing unit 100B executes various processes executed in the image forming apparatus 100.

Furthermore, the image forming apparatus 100 is provided with an image scanning device 130 that scans the document 1A, creates a scanned image 1C, and transmits the scanned image 1C to the server apparatus 200. The image forming apparatus 100 is provided with an operation reception unit 132 that receives various operations and performs display. The details will be described below.

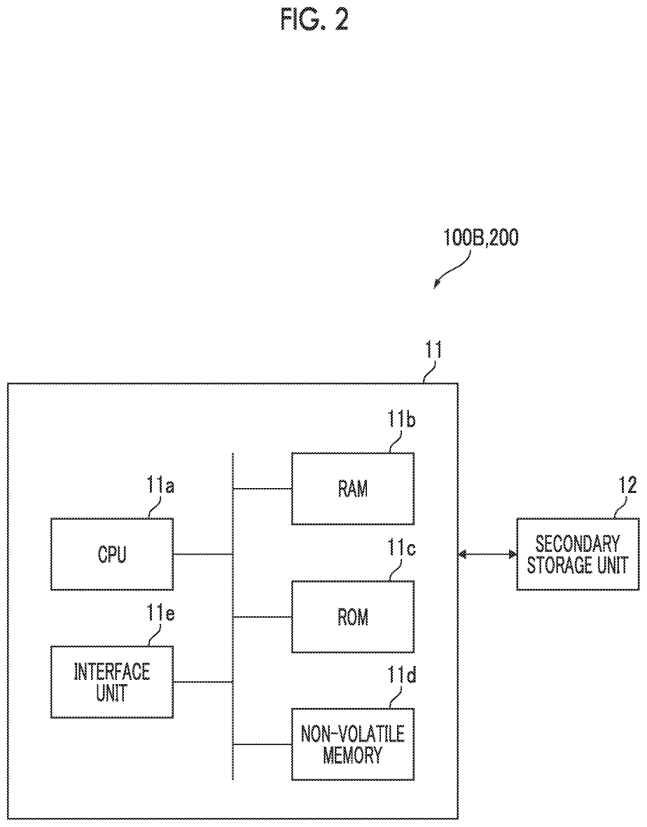

FIG. 2 is a diagram illustrating an example of a hardware configuration of the information processing unit 100B provided in the image forming apparatus 100 and the server apparatus 200. The information processing unit 100B provided in the image forming apparatus 100 and the server apparatus 200 are realized by computers.

Each of the information processing unit 100B and the server apparatus 200 includes an arithmetic processing unit 11 that executes a digital arithmetic process according to a program, and a secondary storage unit 12 that stores information.

The secondary storage unit 12 is realized, for example, by a known information storage device such as a hard disk drive (HDD), a semiconductor memory, or a magnetic tape.

The arithmetic processing unit 11 is provided with a CPU 11a as an example of a processor.

In addition, the arithmetic processing unit 11 is provided with a RAM 11b used as a working memory or the like of the CPU 11a and a ROM 11c in which programs or the like executed by the CPU 11a are stored.

In addition, the arithmetic processing unit 11 is provided with a non-volatile memory 11d that is configured to be rewritable and can hold data even in a case in which power supply is interrupted and an interface unit 11e that controls each unit, such as a communication unit, connected to the arithmetic processing unit 11.

The non-volatile memory 11d is configured by, for example, an SRAM or a flash memory that is backed up by a battery. The secondary storage unit 12 stores the programs executed by the arithmetic processing unit 11 in addition to files and the like.

In the present exemplary embodiment, the arithmetic processing unit 11 reads the program stored in the ROM 11c or the secondary storage unit 12 to perform each process.

The program executed by the CPU 11a can be provided to the server apparatus 200 and the information processing unit 100B in a state in which the program is stored in a computer-readable recording medium such as a magnetic recording medium (for example, a magnetic tape or a magnetic disk), an optical recording medium (for example, an optical disk), a magneto-optical recording medium, or a semiconductor memory. Further, the program executed by the CPU 11a may be provided to the server apparatus 200 and the information processing unit 100B by a communication section such as the Internet.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The processing in the image processing system 1 described below may be performed not only by the CPU 11a as an example of a processor provided in the image forming apparatus 100, but also by the CPU 11a as an example of a processor provided in the server apparatus 200. The processing may be realized by one apparatus such as one server apparatus 200, or may be realized by a plurality of devices.

The term “system” in the present exemplary embodiment includes both a system configured by a plurality of devices and a system configured by a single device.

Returning to FIG. 1, the image forming apparatus 100 will be described.

In the present exemplary embodiment, as described above, the image forming apparatus 100 is provided with the image forming unit 100A that forms an image on paper which is an example of a recording medium.

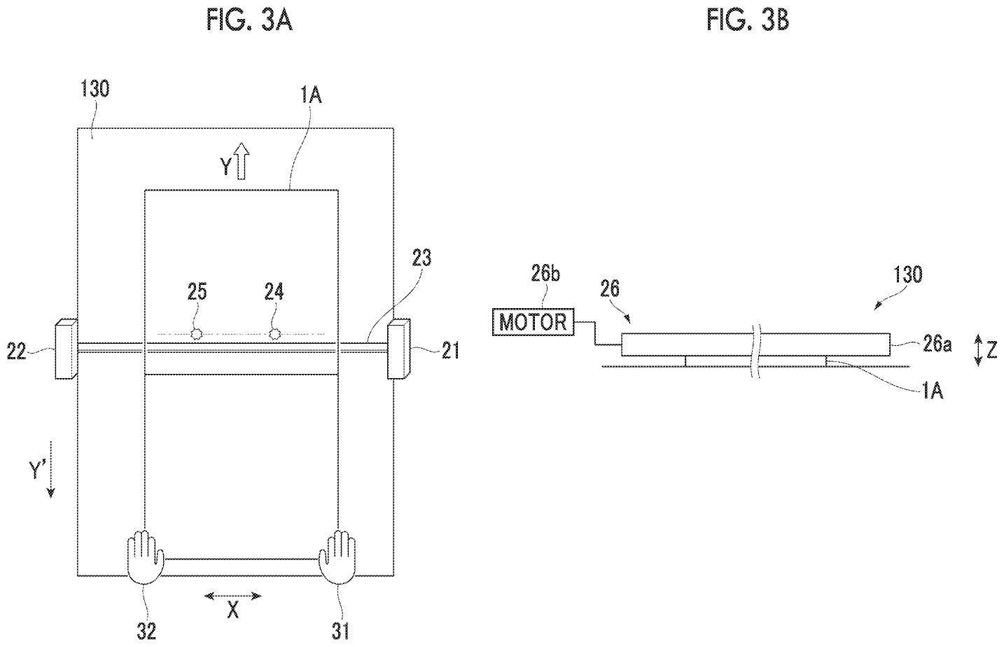

Further, the image forming apparatus 100 is provided with the image scanning device 130 as an example of an image scanning section that scans an image of the document 1A. The image scanning device 130 is a so-called scanner having a transport mechanism 26 (see FIGS. 3A and 3B) for the document 1A, and performs scanning after the transport mechanism 26 transports the document 1A. Image scanning may be referred to as “scanning” below.

The image scanning device 130 includes a light source that emits light with which the document 1A is irradiated, and a light receiving unit such as a CCD, that receives reflected light from the document 1A. In the present exemplary embodiment, a scanned image described later is generated based on the reflected light received by the light receiving unit.

A scanning position for an image is set in advance in the image scanning device 130. The image scanning device 130 sequentially scans an image in an area of the transported document 1A at the scanning position by a line, and reads scanned line data.

In addition, the image forming apparatus 100 has an information transmission function to transmit information to the server apparatus 200 (see FIG. 1).

In the present exemplary embodiment, the image scanning device 130 is provided above the image forming apparatus 100. The image scanning device 130 sequentially scans the document 1A set by the user.

Further, each image forming apparatus 100 is provided with the operation reception unit 132 that receives an operation from the user. The operation reception unit 132 is configured by a so-called touch panel. The operation reception unit 132 displays information for the user and receives an operation performed by the user.

The display of information for the user and the reception of the operation by the user are not limited to being performed by one operation reception unit 132 as in the present exemplary embodiment. The operation reception unit and the information display unit may be provided separately. The operation reception unit 132 is an example of a display unit.

In the present exemplary embodiment, in a case where the document 1A as a scanning target is installed in the image scanning device 130 as indicated by the reference sign 1B in FIG. 1, and a scanning start operation is performed, the transport of the document 1A is started, and the image scanning device 130 scans the document. By scanning the document, the scanned image 1C as data is created.

In the present exemplary embodiment, the scanned image 1C is transmitted to the server apparatus 200 and then is stored in the server apparatus 200.

In the image forming apparatus 100 in the present exemplary embodiment, image formation can be performed on long paper of the A4 size (210 mm×297 mm), the A3 size (420 mm×297 mm), and the size exceeding the A3 size, for example, the A0 size (841 mm×1189 mm) and the size of the A0 width 10 m (841 mm×10000 mm). In addition, image on paper having such a size can be scanned.

Here, the image forming apparatus 100 has a scanning operation mode which is an operation mode in which an image is scanned from the document 1A being transported by the transport mechanism 26 (see FIGS. 3A and 3B) in the image scanning device 130. In such an operation mode, in a case where, in transporting the document 1A by the transport mechanism 26, the document 1A meanders in the right-left direction or is skewed in a transport direction, and thus approaches guide members 21 and 22 (see FIGS. 3A and 3B), the transport by the transport mechanism 26 is temporarily stopped in order to prevent damage to the document 1A. However, in a case where the transport of the document 1A is restarted from the first portion after such a temporary stop, it takes time to complete scanning of the document 1A. In particular, in a case where the document 1A has the long size described above, the scanning operation efficiency may decrease due to the long time required.

Therefore, in the present exemplary embodiment, a configuration in which, in a case where the transport by the transport mechanism 26 is temporarily stopped in the middle of scanning, and then scanning is restarted not from the first portion of the document 1A but from a continuous portion, a scanned image of the document 1A is created is provided. A specific description will be made below.

FIGS. 3A and 3B are diagrams illustrating the configuration of the image scanning device 130. FIG. 3A is a plan view and FIG. 3B illustrates a portion of the transport mechanism 26.

As illustrated in FIG. 3A, the image scanning device 130 includes a pair of guide members 21 and 22 and a light receiving unit 23. The pair of guide members 21 and 22 is provided to be spaced apart from each other in an intersection direction X which is a direction intersecting the transport direction Y of the document 1A. The light receiving unit 23 is located between the pair of guide members 21 and 22 and is provided along the intersection direction X. In addition, the image scanning device 130 includes a plurality of document position sensors 24 and 25 that are located between the pair of guide members 21 and 22 and are provided to be spaced apart from each other in the intersection direction X.

The light receiving unit 23 is an example of a scanning unit that scans an image. The document position sensors 24 and 25 are an example of a detection unit provided separately from the scanning unit. The transport direction Y is an example of a direction of transport. The intersection direction X is an example of a direction intersecting the direction of the transport.

The pair of guide members 21 and 22 are provided on a transport surface and define an area through which the document 1A transported in the transport direction passes. The guide member 21 is located at one end portion in the intersection direction X, and the guide member 22 is located at the other end portion.

The light receiving unit 23 is, for example, an image sensor or the like for scanning the document 1A by receiving the reflected light obtained in a manner that light emitted from the light source is reflected by the document 1A. The light receiving unit 23 can also be an image scanning unit that outputs image data obtained by scanning.

The document position sensors 24 and 25 optically detect the position of the document 1A, and detect whether or not the document 1A is at a predetermined position. That is, the document position sensors 24 and 25 detect the position shift of the document 1A in the intersection direction X. As a result, the information processing unit 100B (see FIG. 1) determines whether or not to temporarily stop the transport of the document 1A.

In the present exemplary embodiment, two document position sensors 24 and 25 are provided. The present exemplary embodiment is not limited to this, and three or more document position sensors may be provided.

As illustrated in FIG. 3B, the transport mechanism 26 includes a transport roller 26a that is rotatably held and a motor 26b that rotationally drives the transport roller 26a.

The transport roller 26a has an elevating mechanism (not illustrated) that is displaceable in the up-down direction Z and can select an upper position and a lower position. In a case where the lower position is selected, the transport roller 26a is in a nip state of pressing the upper surface of the document 1A. At the upper position, the transport roller 26a is in a non-nip state of not coming into contact with the upper surface of the document 1A. In a case where the motor 26b operates at the lower position, the transport roller 26a rotates, and the document 1A is transported in the transport direction Y.

The right-hand FIG. 31 and the left-hand FIG. 32 in FIG. 3A exemplify that the user puts a hand on the transported document 1A.

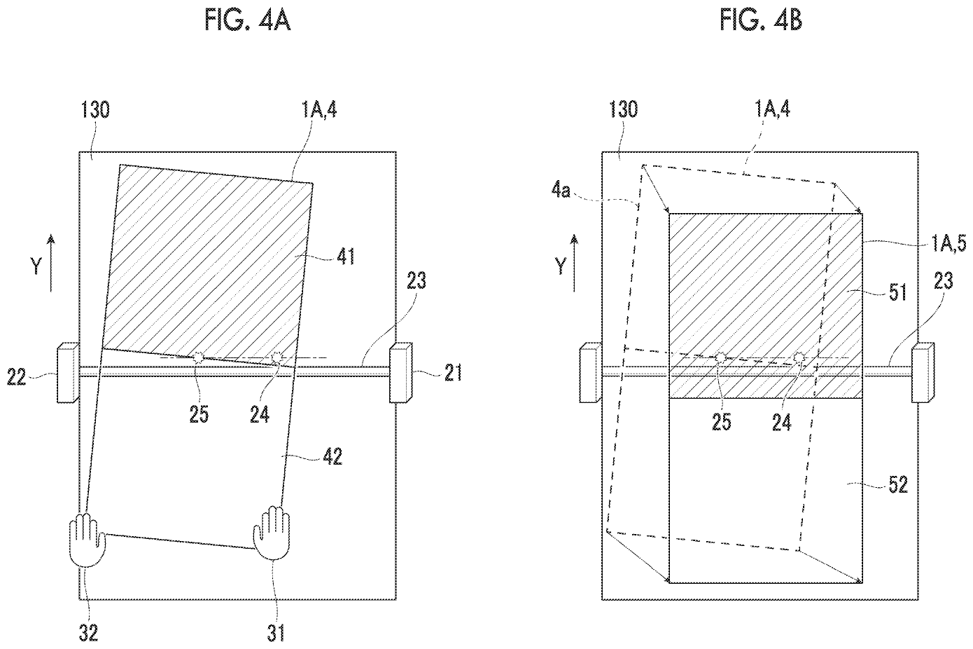

FIGS. 4A and 4B are diagrams illustrating the scanning operation mode of the image scanning device 130. FIG. 4A illustrates a case where transport of the document 1A is temporarily stopped. FIG. 4B illustrates a case where the document 1A is moved from stop of transport to restart of the transport. For convenience of description, description will be made by using the document 1A with different reference signs for a state in which the transport is temporarily stopped and a state in which the transport is restarted. That is, the document 1A in a state in which the transport is stopped is set as a document 4, and the document 1A in a state in which the transport is restarted is set as a document 5. Further, in FIG. 4B, the document 4 is indicated by a broken line, and the document 5 is indicated by a solid line.

The document 4 illustrated in FIG. 4A is in a state where the document 4 is transported in an oblique state and approaches the guide member 22 on the left side, and thus transport is temporarily stopped. In image scanning (first partial scanning) performed during a period from the start of scanning by the light receiving unit 23 to the temporary stop of the transport, the document image necessary for creating the scanned image 1C (see FIG. 1) is not acquired. That is, although an area 41 indicated by the diagonal lines in the document 4 has been scanned, the remaining area 42 has not yet been scanned.

Such a temporary stop of the transport may be a case of a manual stop in which the transport is stopped by the user operating a stop button (not illustrated) in addition to a case of an automatic stop in which the transport is stopped in a case where the meandering or skewing of the document 1A being transported is detected.

Further, in the present exemplary embodiment, the document position sensors 24 and 25 described above detect the oblique state for the automatic stop, but the present exemplary embodiment is not limited to this. The light receiving unit 23 may detect the oblique state, and both the document position sensors 24 and 25 and the light receiving unit 23 may detect the oblique state.

FIG. 4B illustrates the document 5 (refer to the solid line) obtained by moving the document 4 (refer to the broken line) in an oblique state and in which transport has been stopped, to a state in which transport is restarted. That is, the document 5 corrects the oblique state (see the broken line) of the document 4 in which the transport has been stopped so that the long side 4a of the document 4 is along the transport direction Y, and then the document 4 is brought back from a position at which transport of the document 4 is stopped to the rear side in the transport direction Y.

In a case where the document 4 is brought back to the rear side in the transport direction, the user sets the transport roller 26a (see FIG. 3B) at the upper position so as not to come into contact with the document 4, and releases the document pressing. Further, at the time of restart, the document 5 is pressed with the transport roller 26a at the lower position, and the start button (not illustrated) is pressed.

An area 51 of the document 5 indicated by the diagonal lines in FIG. 4B corresponds to the area 41 of the document 4 indicated by the diagonal lines in FIG. 4A. An area 52 of the document 5 corresponds to the area 42 of the document 4.

By transporting the document 5 from the position illustrated in FIG. 4B in the transport direction Y by the transport roller 26a (see FIG. 3B), scanning by the light receiving unit 23 is restarted, and the document 5 is scanned. Such scanning is scanning of the area 52 of the document 5 (second partial scanning).

As described above, in the scan illustrated in FIG. 4A, the area 41 of the document 4 is scanned, and, in the scan illustrated in FIG. 4B, the area 52 of the document 5 is scanned.

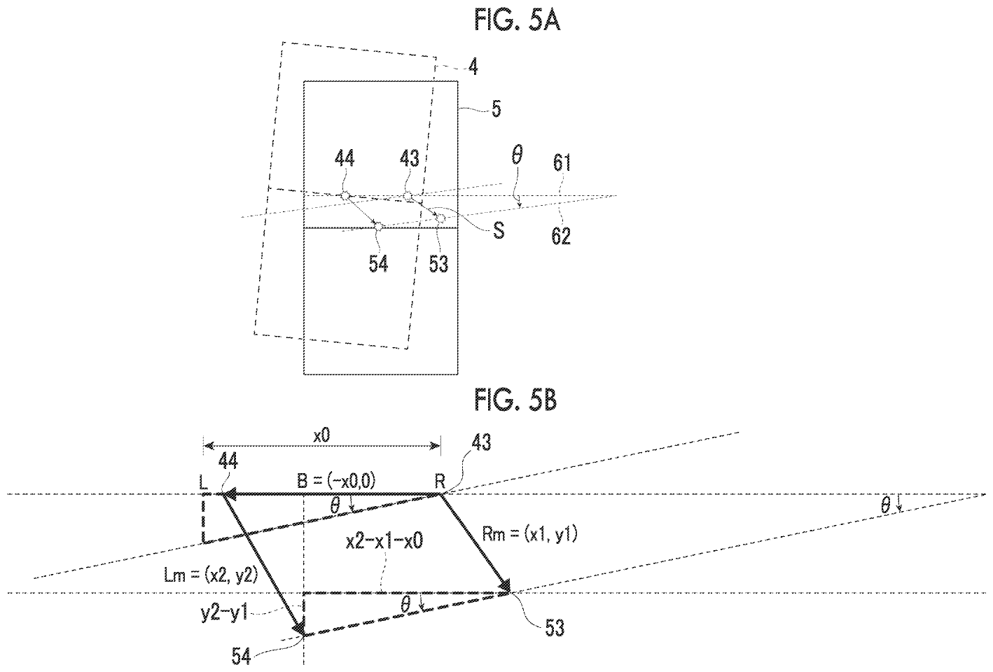

FIGS. 5A and 5B are diagrams illustrating information indicating the movement of the document in a case where transport is stopped. FIG. 5A is a diagram corresponding to FIG. 4B, and FIG. 5B is a diagram illustrating a method for calculating a movement amount and a rotation angle.

As illustrated in FIG. 5A, a reference position 43 in the document 4 is displaced to a reference position 53 in the document 5, and a reference position 44 in the document 4 is displaced to a reference position 54 in the document 5.

The reference positions 43 and 44 are the positions of the document position sensors 24 and 25 (see FIG. 4B) in the case of the document 4. The reference positions 53 and 54 are the positions of the document position sensors 24 and 25 in the case of the document 5.

The document position sensors 24 and 25 detect the correction of the document position by the user, which is the position shift from the document 4 to the document 5, as the document movement amount of the sensor position. Therefore, the movement amount, that is, the rotation amount or the rotation angle (referred to as a rotation angle below) θ and the offset movement amount (referred to as an offset amount below) S are obtained based on information of the detected document movement amount. From the obtained rotation angle θ and offset amount S, it is possible to specify the joint positions of the document before and after the temporary stop. The rotation angle θ is an example of a rotation amount, and the offset amount S is an example of a movement amount.

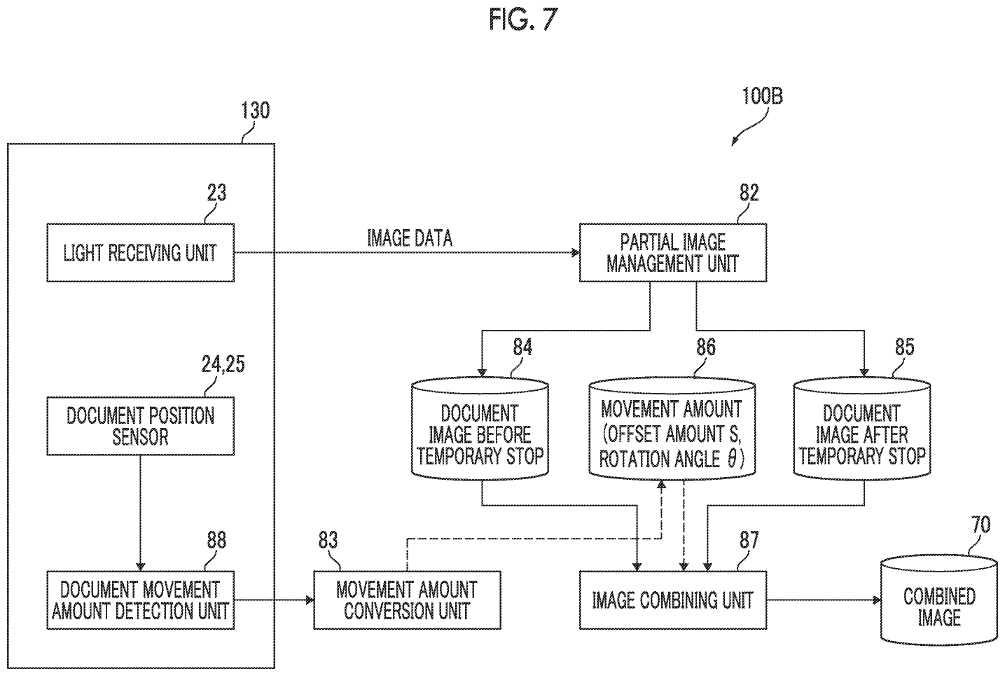

As described above, the rotation angle θ and the offset amount S can be obtained by using the information of the reference positions 43, 44, 53, and 54 by the document position sensors 24 and 25. That is, an intersection angle between a line segment 61 including the reference positions 43 and 44 and a line segment 62 including the reference positions 53 and 54 is the rotation angle θ. Further, a distance from the reference position 43 to the reference position 53 is defined as the offset amount S. The movement amount is calculated by a movement amount conversion unit 83 (see FIG. 7) described later, and is an example of information indicating the movement of the document at the time of stopping the transport.

The document movement amount is information detected by the document position sensors 24 and 25, but may include information detected by the light receiving unit 23. In such a case, the information detected by the light receiving unit 23 is an example of the information detected by the scanning unit.

A more detailed description will be made with reference to FIG. 5B.

The distance from the reference position 43 to the reference position 53, which is detected by the document position sensor 24 (see FIG. 4B), is defined as Rm=(x1, y1). Further, the distance from the reference position 44 to the reference position 54, which is detected by the document position sensor 25 (see FIG. 4B), is defined as Lm=(x2, y2). Further, the distance between the document position sensors 24 and 25, that is, the distance between the reference position 43 and the reference position 44 is defined as x0.

Assuming that the document position sensor 24, that is, the reference position 43 is the reference origin, the offset amount S can be obtained by

S=Rm=(x1,y1)

Further, the rotation angle θ can be obtained as follows.

$$Direction vector : B + L m - Rm = ( - x 0 + x 2 - x 1 , y 2 - 1 )$$

$$θ = arctan ( ( y 2 - y 1 ) / ( x 2 - x 1 - x 0 ) )$$

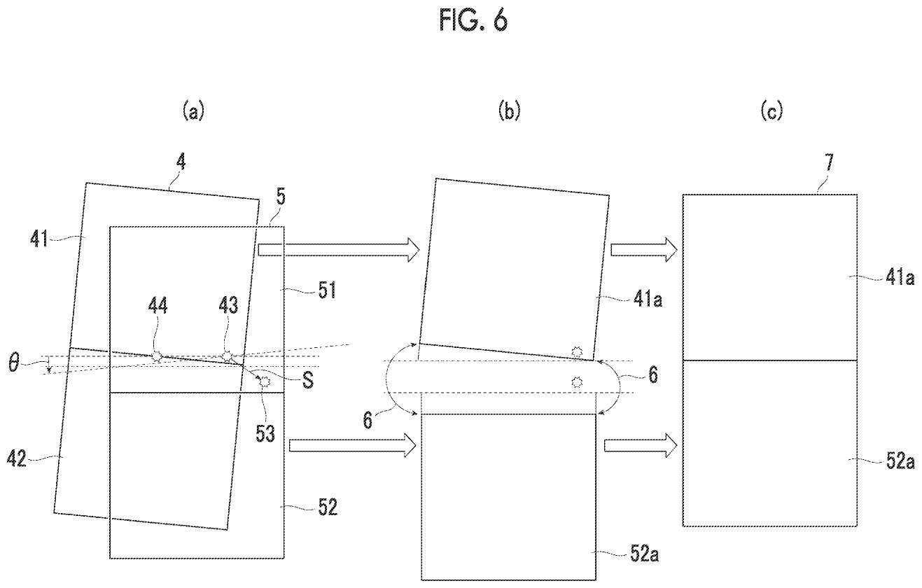

FIG. 6 is diagrams illustrating creation of a combined image 7 obtained by combination. (a) of FIG. 6 is a diagram illustrating the documents 4 and 5. (b) of FIG. 6 is a diagram illustrating document images 41a and 52a. (c) of FIG. 6 is a diagram illustrating a combined image 7. The combined image 7 is the scanned image 1C (see FIG. 1).

In a case where the rotation angle θ and the offset amount S illustrated in (a) of FIG. 6 can be obtained, as illustrated in (b) of FIG. 6, the positional relationship between the document image 41a of the document 4 read before the temporary stop and the document image 52a of the document 5 read after the temporary stop is specified. Thus, rotation and an offset movement are performed on the document image 41a (see the arrow 6), and in this manner, the position of the document image 41a is caused to coincide with the position of the document image 52a.

As illustrated in (c) of FIG. 6, the combined image 7 is created by combining the document images 41a and the document images 52a having the positions that coincide with each other.

In the present exemplary embodiment, the document image 41a is combined after being rotated and offset-moved to coincide with the position of the document image 52a. However, the present exemplary embodiment is not limited to this, and the combination may be performed after adjustment using a point that the document images at portions at which duplicate scanning is performed in addition to the offset amount S.

Next, the functional configuration in the present exemplary embodiment will be described.

FIG. 7 is a block diagram illustrating the functional configuration in the present exemplary embodiment.

In the configuration example illustrated in FIG. 7, the image scanning device 130 includes the above-described light receiving unit 23 and a document movement amount detection unit 88 that detects a document movement amount from the detection results of the document position sensors 24 and 25.

In addition, the information processing unit 100B includes a partial image management unit 82 that manages the image data generated by the light receiving unit 23, and a movement amount conversion unit 83 that converts the detection result of the document movement amount detection unit 88 into a movement amount.

In addition, the information processing unit 100B includes image storage units 84 and 85 that store the image managed by the partial image management unit 82 and a movement amount storage unit 86 that stores the movement amount (offset amount S, rotation angle θ) converted by the movement amount conversion unit 83.

The document image (document image before the temporary stop) scanned before the temporary stop is stored in the image storage unit 84. The document image (document image after the temporary stop) scanned after the temporary stop is stored in the image storage unit 85.

The movement amount converted by the movement amount conversion unit 83, that is, the offset amount S and the rotation angle θ are stored in the movement amount storage unit 86.

In addition, the information processing unit 100B includes an image combining unit 87 and an image storage unit 70.

The image combining unit 87 combines a scanned image by using the document images stored in the image storage units 84 and 85 and the movement amount stored in the movement amount storage unit 86.

The image storage unit 70 stores a combined image 7 (see (c) of FIG. 6) obtained by combination of the image combining unit 87.

Although the configuration in which the information processing unit 100B of the image forming apparatus 100 performs the image processing has been described, the present exemplary embodiment is not limited to this. The server apparatus 200 may perform the image processing.

The information processing unit 100B of the image forming apparatus 100 or the server apparatus 200 is an example of the information processing apparatus.

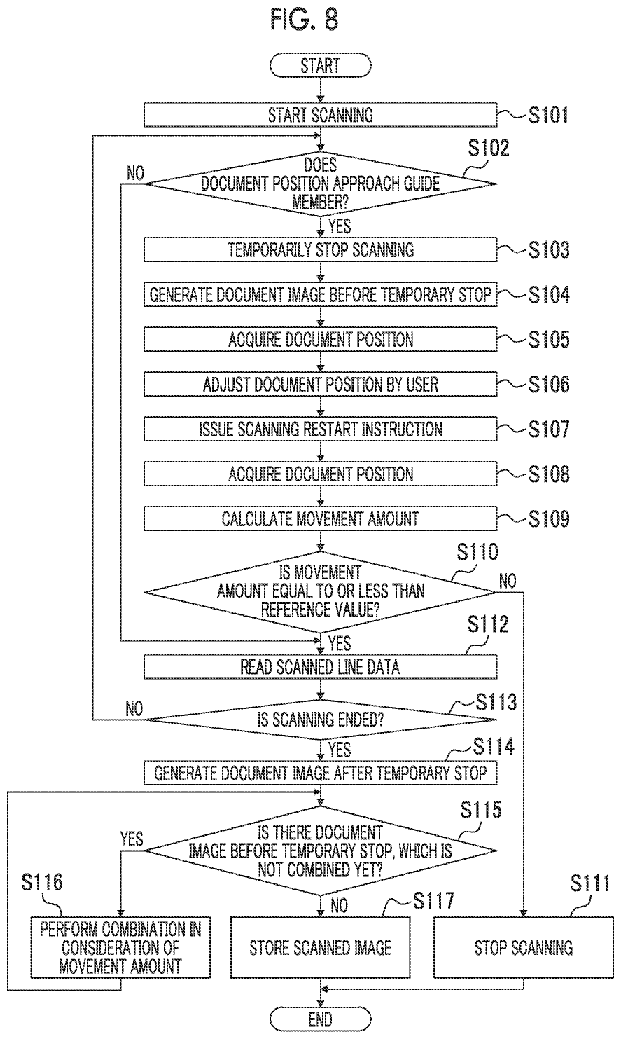

FIG. 8 is a flowchart illustrating a processing procedure in a case where scanning is performed.

In the processing example illustrated in FIG. 8, in a case where a document 1A (see FIGS. 3A and 3B) is transported and scanning by the light receiving unit 23 is started (Step S101), whether or not the position of the document approaches any of the guide members 21 and 22 (see FIG. 4A) by the transport is determined from the detection results of the document position sensors 24 and 25 (Step S102).

In a case where the document approaches the guide member (Yes in Step S102), the document transport is stopped, and scanning is temporarily stopped (Step S103), and a document image before the temporary stop is generated (Step S104). The generated document image is managed by the partial image management unit 82 (see FIG. 7) and is stored in the image storage unit 84 (see FIG. 7). In a case of the temporary stop, a display may be performed on the operation reception unit 132 (see FIG. 1) so that the position of the document is adjusted and scanning is restarted.

In a case where the document does not approach the guide member (No in Step S102), the scan is continued, and the process proceeds to Step S112 described later.

The document movement amount detection unit 88 acquires position information of the temporarily stopped document (Step S105). Such position information is the above-described reference positions 43 and 44 (see FIG. 5A) and is acquired by the document position sensors 24 and 25 (see FIG. 4A), but may be acquired by the light receiving unit 23.

Thereafter, in a case where the user adjusts the document position (Step S106) and gives an instruction to restart scanning by an operation of a start button (not illustrated) (Step S107), the document movement amount detection unit 88 acquires position information of the corrected document (Step S108).

The guidance display for the adjustment of the document position referred to here may be performed by the operation reception unit 132 (see FIG. 1).

Here, in addition to the case where the document is transported from the document position adjusted by the user and the scanning is restarted, a configuration may be made such that an unscanned portion of the document is not generated. For example, the transport mechanism 26 (see FIG. 3B) is controlled so that the document is transported in the transport direction Y after transporting the document in a direction Y′ (see FIG. 3A, for example) opposite to the transport direction Y by a predetermined distance. As a result, the scan is started from the front side in the transport direction with respect to a position in transport stop.

In addition to the control of the transport mechanism 26, the operation reception unit 132 (see FIG. 1) may perform the display indicating that the position of the document is adjusted such that transport is started from the front side in the transport direction with reference to the document position in transport stop. In this manner, the user may be alerted.

The opposite direction Y′ is an example of a direction opposite to the direction of the transport.

After the scanning restart instruction (see Step S107), the movement amount conversion unit 83 (see FIG. 7) calculates the movement amount based on the position information of the temporarily stopped document and the position-adjusted document (Step S109). The movement amount is calculated with the position information in Step S105 as a start point and the position information in Step S108 as an end point. For example, the movement amount may be calculated with the start point as the origin and the end point as relative coordinate values with respect to the origin, or may be calculated by setting the start point and the end point as absolute coordinate values.

As described above, the movement amount calculated in this manner is the rotation angle θ and the offset amount S (see FIG. 5A).

It is determined whether or not the calculated movement amount is equal to or less than a predetermined reference value (Step S110). In a case where the movement amount is more than the predetermined reference value (No in Step S110), scanning is stopped (Step S111). For example, the scan is stopped in a case where an error is large. In a case where such scanning is stopped, the operation reception unit 132 (see FIG. 1) may notify the user.

The “case where the movement amount is more than the predetermined reference value” referred to herein is an example of a case where the movement based on information indicating the movement of the document at the time of stopping transport is predetermined.

In a case where it is not possible to acquire the position information of the document because the document is extracted without adjusting the position after the temporary stop, scanning may be stopped in the same manner.

On the other hand, in a case where the movement amount is equal to or less than the predetermined reference value (Yes in Step S110), document transport is restarted, scanned line data is read (Step S112). Then, it is determined whether or not the scan has been completed (Step S113). Such determination is performed, for example, based on the detection results obtained by the document position sensors 24 and 25.

In a case where the scanning is not completed (No in Step S113), the process returns to Step S102 described above. As described above, the number of temporary stops is not limited to one, and a plurality of temporary stops may be performed. Even in a case of a plurality of times, the combined image 7 (see (c) of FIG. 6) can be created by the method described above.

In a case where scanning has been completed (Yes in Step S113), a document image after the temporary stop is generated (Step S114). The document image after the temporary stop referred here is the document image in the case of being temporarily stopped (Yes in Step S102), but also includes the document image in the case of not being temporarily stopped (No in Step S102).

After generating the document image after the temporary stop (Step S114), it is determined whether or not there is a document image before the temporary stop, which is not combined yet (Step S115). In a case where there is such a document image (Yes in Step S115), the document image before the temporary stop (see Step S104) and the document image after the temporary stop (see Step S114) are combined in consideration of the movement amount (Step S116). Then, the process returns to Step S115.

In a case where there is no document image before the temporary stop, which is not combined (No in Step S115), the combined image 7 obtained by the combination is stored as a scanned image in the image storage unit 70 (see FIG. 7) (Step S117).

Next, the contents displayed in the operation reception unit 132 (see FIG. 1) in a case where the processing procedure in FIG. 8 is temporarily stopped will be described.

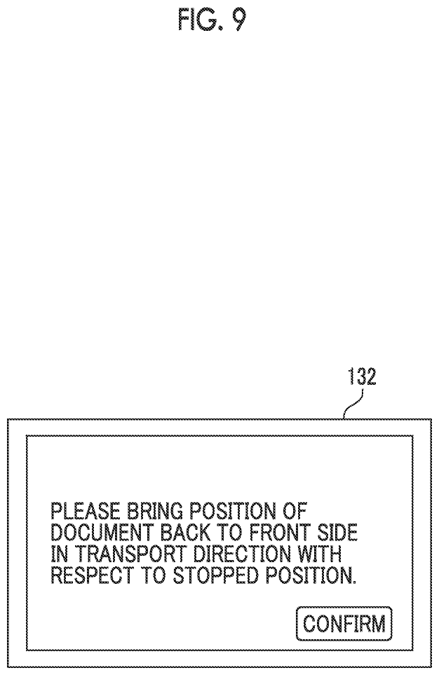

FIG. 9 is a diagram illustrating a first display example of the operation reception unit 132 (see FIG. 1).

The first display example illustrated in FIG. 9 is displayed on the operation reception unit 132 in a case where the processing procedure in FIG. 8 is temporarily stopped (see Step S103). A message that “please bring the position of the document back to the front side in the transport direction with respect to the stopped position” is displayed to the user.

Thus, scanning is started from the front side in the transport direction with respect to the position in transport stop, even without performing control for transporting the document in the transport direction after transporting the document in the direction opposite to the transport direction by the predetermined distance. As a result, it is possible to prevent an occurrence of a situation in which a portion of the document that is not scanned occurs.

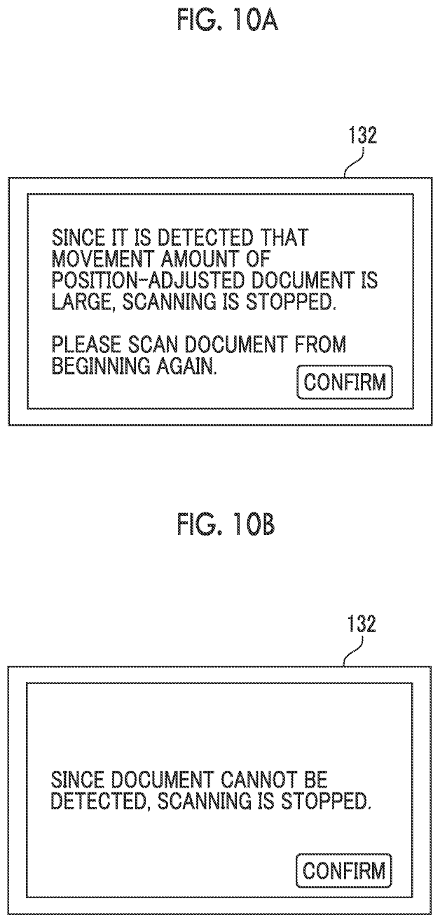

FIGS. 10A and 10B are diagrams illustrating other display examples of the operation reception unit 132 (see FIG. 1). FIG. 10A illustrates a second display example, and FIG. 10B illustrates a third display example.

In each of the other display examples illustrated in FIGS. 10A and 10B, the scan is displayed on the operation reception unit 132 in a case where scanning is stopped in a case of being temporarily stopped (see Step S111 in FIG. 8).

In the second display example illustrated in FIG. 10A, a guidance display indicating that “since it is detected that the movement amount of the position-adjusted document is large, scanning is stopped.” and “please scan the document from the beginning again” are performed for the user. Accordingly, a notification of the operation to be performed next by the user who has adjusted the position of the document is performed, so that the operability can be improved.

In the third display example illustrated in FIG. 10B, a guidance display indicating that “since the document cannot be detected, scanning is stopped.” This saves the time and effort for the user who has extracted the document to perform the operation of stopping the scanning, thereby improving the operability.

### Supplementary Note

(((1)))

An image processing system comprising:
one or a plurality of processors configured to:
   in an operation mode in which an image is scanned from a document being transported by a transport mechanism,
   in a case where transport of the document by the transport mechanism is stopped and then the transport is restarted before scanning of the document by the transport mechanism is ended, create a scanned image of the document by using a document image scanned before stop of the transport and a document image scanned by restart of the transport, based on information indicating a movement of the document at a time of stopping the transport.
      (((2)))

The image processing system according to (((1))), further comprising:
a transmission section that transmits a scanning result of an image scanning unit,
wherein the information indicating the movement of the document includes information detected by a detection unit provided separately from a scanning unit that scans an image.
   (((3)))

The image processing system according to (((2))),
wherein the detection unit provided separately detects a position shift of a document in a direction intersecting a direction of the transport in order to determine whether or not the transport of the document by the transport mechanism is stopped.
   (((4)))

The image processing system according to (((2))) or (((3))),
wherein the information indicating the movement of the document includes information detected by the scanning unit.
   (((5)))

The image processing system according to any one of (((1))) to (((4))),
wherein a rotation amount and a movement amount of the document at a time of the restart are obtained with respect to the document at a time of stopping the transport, from the information indicating the movement of the document, and
the obtained rotation amount and movement amount are used to create the scanned image.
   (((6)))

The image processing system according to (((1))),
wherein, in a case where the transport of the document is stopped, generation of an unscanned portion of the image at a time of the restart is prevented.
   (((7)))

The image processing system according to (((6))),
wherein, in order to prevent the generation of the unscanned portion, display is performed to a user so that the scanning at the time of restarting the transport is started from a front side in a transport direction with respect to a position of the document at which the transport is stopped.
   (((8)))

The image processing system according to (((6))),
wherein, in order to prevent the generation of the unscanned portion, the transport mechanism transports the document in a direction opposite to a direction of the transport so that the scanning at the time of restarting the transport is started from a front side in the direction of the transport with respect to a position of the document at which the transport is stopped.
   (((9)))

The image processing system according to (((1))),
wherein, in a case where the transport of the document is stopped, and a movement of the document is predetermined by information indicating the movement of the document at a time of stopping the transport, a message that the operation mode is stopped is displayed on a display unit.
   (((10)))

The image processing system according to (((1))),
wherein, in a case where the transport of the document is stopped, and presence of the document is not detected, a message that the operation mode is stopped is displayed on a display unit.
   (((11))

A program causing an information processing apparatus to realize:
a function of acquiring information indicating a movement of a document at a time of stopping transport in a case where, in an operation mode in which an image is scanned from the document being transported by a transport mechanism, the transport of the document by the transport mechanism is stopped, and then the transport is restarted before scanning of the document by the transport mechanism is ended; and
a function of creating a scanned image based on the acquired information by using a document image scanned before stop of the transport and a document image scanned by restart of the transport.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing system comprising:
one or a plurality of processors configured to:
in an operation mode in which an image is scanned from a document being transported by a transport mechanism,
in a case where transport of the document by the transport mechanism is stopped and then the transport is restarted before scanning of the document by the transport mechanism is ended, create a scanned image of the document by using a document image scanned before stop of the transport and a document image scanned by restart of the transport, based on information indicating a movement of the document at a time of stopping the transport.

2. The image processing system according to claim 1,
wherein the information indicating the movement of the document includes information detected by a detection unit provided separately from a scanning unit that scans an image.

3. The image processing system according to claim 2,
wherein the detection unit provided separately detects a position shift of a document in a direction intersecting a direction of the transport in order to determine whether or not the transport of the document by the transport mechanism is stopped.

4. The image processing system according to claim 2,
wherein the information indicating the movement of the document includes information detected by the scanning unit.

5. The image processing system according to claim 1,
wherein a rotation amount and a movement amount of the document at a time of the restart are obtained with respect to the document at a time of stopping the transport, from the information indicating the movement of the document, and
the obtained rotation amount and movement amount are used to create the scanned image.

6. The image processing system according to claim 1,
wherein, in a case where the transport of the document is stopped, generation of an unscanned portion of the image at a time of the restart is prevented.

7. The image processing system according to claim 6,
wherein, in order to prevent the generation of the unscanned portion, display is performed to a user so that the scanning at the time of restarting the transport is started from a front side in a transport direction with respect to a position of the document at which the transport is stopped.

8. The image processing system according to claim 6,
wherein, in order to prevent the generation of the unscanned portion, the transport mechanism transports the document in a direction opposite to a direction of the transport so that the scanning at the time of restarting the transport is started from a front side in the direction of the transport with respect to a position of the document at which the transport is stopped.

9. The image processing system according to claim 1,
wherein, in a case where the transport of the document is stopped, and a movement of the document is predetermined by information indicating the movement of the document at a time of stopping the transport, a message that the operation mode is stopped is displayed on a display unit.

10. The image processing system according to claim 1,
wherein, in a case where the transport of the document is stopped, and presence of the document is not detected, a message that the operation mode is stopped is displayed on a display unit.

11. A non-transitory computer readable medium storing a program causing an information processing apparatus to realize:
a function of acquiring information indicating a movement of a document at a time of stopping transport in a case where, in an operation mode in which an image is scanned from the document being transported by a transport mechanism, the transport of the document by the transport mechanism is stopped, and then the transport is restarted before scanning of the document by the transport mechanism is ended; and
a function of creating a scanned image based on the acquired information by using a document image scanned before stop of the transport and a document image scanned by restart of the transport.

12. An image processing method comprising:
acquiring information indicating a movement of a document at a time of stopping transport in a case where, in an operation mode in which an image is scanned from the document being transported by a transport mechanism, the transport of the document by the transport mechanism is stopped, and then the transport is restarted before scanning of the document by the transport mechanism is ended; and
creating a scanned image based on the acquired information by using a document image scanned before stop of the transport and a document image scanned by restart of the transport.
